(19) United States
(12) Patent Application Publication
(10) Pub. No.: US 2020/0017265 A1
(43) Pub. Date: Jan. 16, 2020

(54) BEVERAGE FLAVOR STRIP SYSTEM AND METHOD

(71) Applicant: Johnny Darrel Loftis, JR., League City, TX (US)

(72) Inventor: Johnny Darrel Loftis, JR., League City, TX (US)

(21) Appl. No.: 16/404,897

(22) Filed: May 7, 2019

Related U.S. Application Data
(60) Provisional application No. 62/697,331, filed on Jul. 12, 2018.

(51) Int. Cl. B65D 65/46; A23L 2/60; A23L 2/06; A23L 27/12

(52) U.S. Cl. CPC B65D 65/463; A23L 27/13; A23L 2/06; A23L 2/60

(57) ABSTRACT

A beverage flavor strip (BFS) system/method allowing edible flavoring to be attached to the outside of a beverage container (BC) is disclosed. The system/method integrates an edible strip layer (ESL), edible flavoring layer (EFL), first edible adhesive layer (FEA), second edible adhesive layer (SEA), and release material layer (RML) into a unified BFS that may be attached to the outside of a BC. The ESL is formed with a first outward face (FOF) and a second inward face (SIF). The FOF and SIF are coated with the FEA/SEA respectively to form a first adhesive side (FAS) and a second adhesive side (SAS). The FAS is coated with the EFL and the SAS is coated with the RML. The RML may be removed from the SAS to allow the SEA to be attached to the BC and expose the EFL for beverage flavor enhancement by the beverage consumer.

### CROSS REFERENCE TO RELATED APPLICATIONS

### Provisional Patent Applications

This application claims benefit under 35 U.S.C. § 119 and incorporates by reference United States Provisional Patent Application for NOVEL EDIBLE FLAVORED STRIP THAT ADHERES TO HAND HELD BEVERAGE CONTAINERS by inventor Johnny Darrel Loftis, Jr., filed electronically with the USPTO on 12 Jul. 2018, with Ser. No. 62/697,331, EFS ID 33167066, confirmation number 3663.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention relates to the application of edible flavored strips to beverage containers. More particularly, the present invention relates an edible flavored strip (EFS) of various flavors, sizes, and shapes that may be attached to beverage containers made of any material and of any shape.

### BACKGROUND AND PRIOR ART

Beverage flavor enhancement through the application of flavored salts and/or sugars on beverage containers has been a fast-growing interest for many consumers. The application may include placing the flavored salts and/or sugars on the top of the beverage container or on the side where the consumer would lick or consume the flavored salt and/or sugar then drink the beverage thereby enhancing the flavor profile. This flavor enhancement is commonly referred to as “dressing a beer” for beverage cans and bottles or “cocktail rimmers” for cups and glasses.

Beverage flavor enhancement through the application of flavored salts and/or sugars on the beverage containers suffers from several drawbacks. The application of flavored salts and/or sugars to a beverage container requires a sticky (usually liquid) substance to be first applied then the salt and/or sugar to be poured or pressed on the beverage container. This process creates a mess and is significantly wasteful with respect to the over-poured liquid substance and salt and/or sugar.

Therefore a need exists in the field for edible flavored strips that adhere to beverage containers. A further need exists for edible flavored strips of various shapes and sizes that adhere to beverage containers made of any material and of varying shapes and sizes.

### BRIEF SUMMARY OF THE INVENTION

The present invention comprises of a edible flavored strip generally consisting of an edible material. More particularly the strip is generally consisting of gelatin, sugar, and water. The front side of the strip contains a flavored substance that adheres to front surface of the strip using an edible adhesive. More particularly the front of the strip contains a flavored substance which generally consists of salt and/or sugar and adheres to the front surface of the strip using an edible adhesive which generally consists of corn syrup and water. The back side of the strip consists of a release material that is adhered to the back side of the strip using an edible adhesive. More particularly the back side of the strip generally consists of silicone parchment paper and is adhered to the back side of the strip using an edible adhesive generally consisting of corn syrup and water.

### BRIEF DESCRIPTION OF THE DRAWINGS

For a fuller understanding of the advantages provided by the invention, reference should be made to the following detailed description together with the accompanying drawings wherein:

FIG. 1 illustrates a block diagram depicting a preferred exemplary invention system embodiment;

FIG. 2 illustrates a flowchart depicting a preferred exemplary invention setup method embodiment;

FIG. 3 illustrates a right front top perspective and side views of a preferred exemplary invention embodiment depicting various layers in the beverage flavor strip (BFS);

FIG. 4 illustrates a right front top perspective view of a preferred exemplary invention embodiment depicting various layers in the beverage flavor strip (BFS) with different sizes to clarify the stacking structure of the BFS;

FIG. 5 illustrates a right rear top perspective view of a preferred exemplary invention embodiment depicting various layers in the beverage flavor strip (BFS) with different sizes to clarify the stacking structure of the BFS

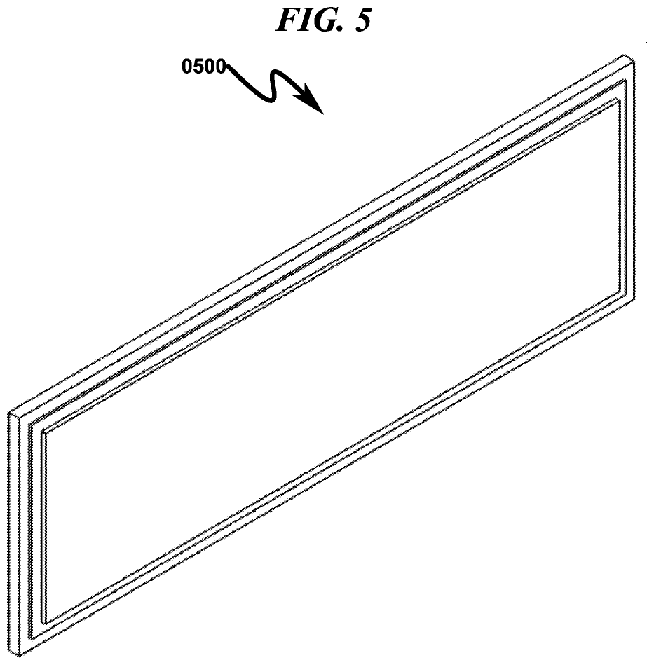

FIG. 6 illustrates a right front top perspective right side section view of a preferred exemplary invention embodiment depicting various layers in the beverage flavor strip (BFS) with different sizes to clarify the stacking structure of the BFS;

FIG. 7 illustrates a right front top perspective view of a preferred exemplary invention embodiment depicting various layers in the beverage flavor strip (BFS) incorporating a release material layer (RML) tab for removal of the RML;

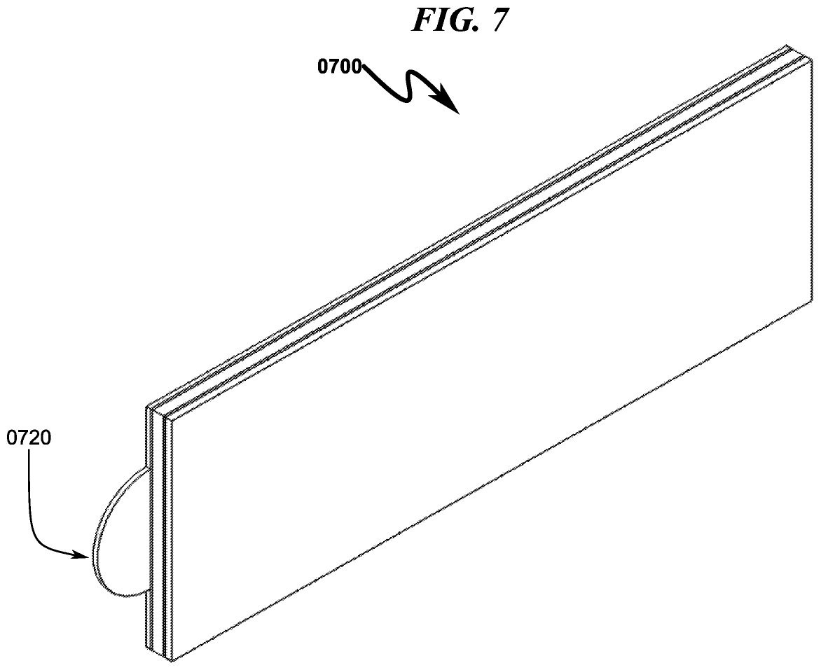

FIG. 8 illustrates a left rear top perspective view of a preferred exemplary invention embodiment depicting various layers in the beverage flavor strip (BFS) incorporating a release material layer (RML) tab for removal of the RML;

FIG. 9 illustrates a right top front and rear perspective views of a preferred exemplary invention embodiment depicting various layers in the beverage flavor strip (BFS) incorporating projected FEA alternative construction;

FIG. 10 illustrates a right top front and rear perspective views of a preferred exemplary invention embodiment depicting various layers in the beverage flavor strip (BFS) incorporating projected FEA alternative construction with EFL, FEA, and RML omitted to show perforation of the ESL to allow the FEA to project to the RML;

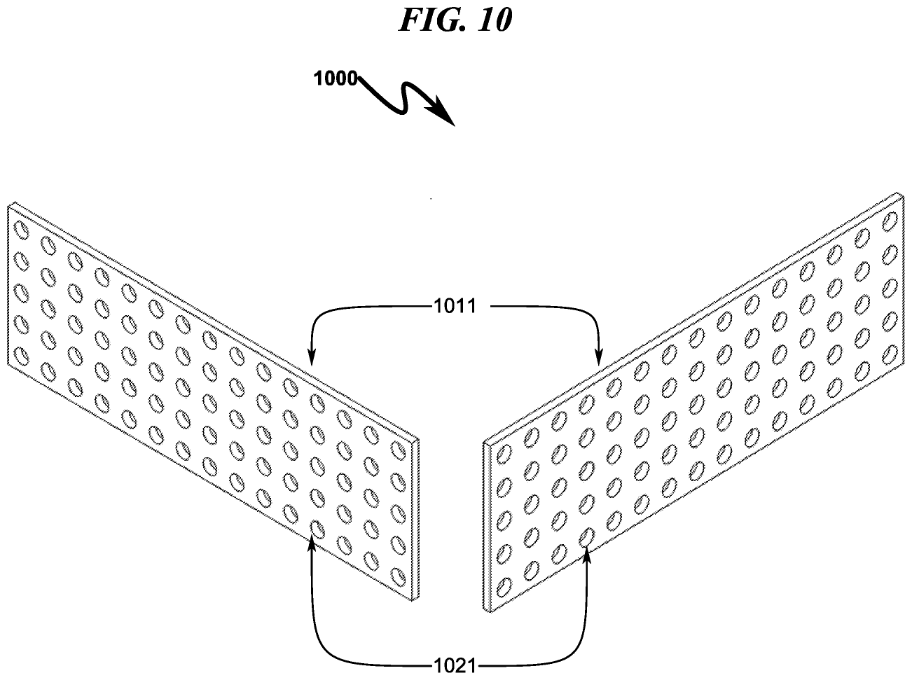

FIG. 11 illustrates a right top front and rear perspective views of a preferred exemplary invention embodiment depicting various layers in the beverage flavor strip (BFS) incorporating projected FEA alternative construction with EFL, ESL, and RML omitted to show projections of the FEA to allow the FEA to project to the RML;

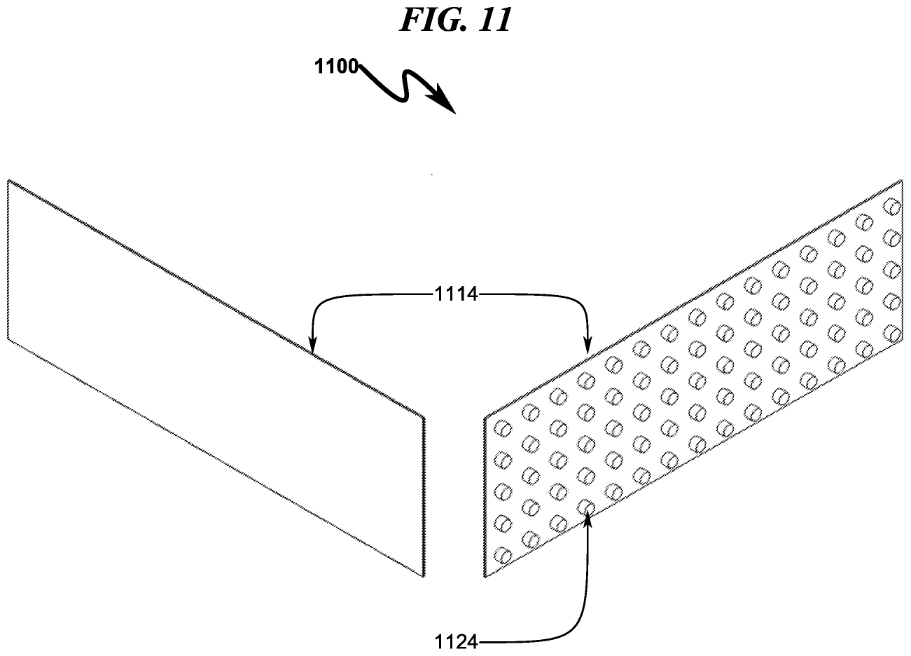

FIG. 12 illustrates a right front top perspective top and right side sectional views of a preferred exemplary invention embodiment depicting various layers in the beverage flavor strip (BFS) incorporating projected FEA alternative construction with EFL and FEA omitted to show perforation of the ESL to allow the FEA to project to the RML;

FIG. 13 illustrates a right top front and rear perspective views of a preferred exemplary invention embodiment depicting various layers in the beverage flavor strip (BFS) incorporating overlapping FEA alternative construction;

FIG. 14 illustrates a right front top perspective view of a preferred exemplary invention embodiment depicting various layers in the beverage flavor strip (BFS) incorporating overlapping FEA alternative construction with EFL and FEA omitted to show overlapping of the ESL by the FEA to allow the FEA to contact the RML;

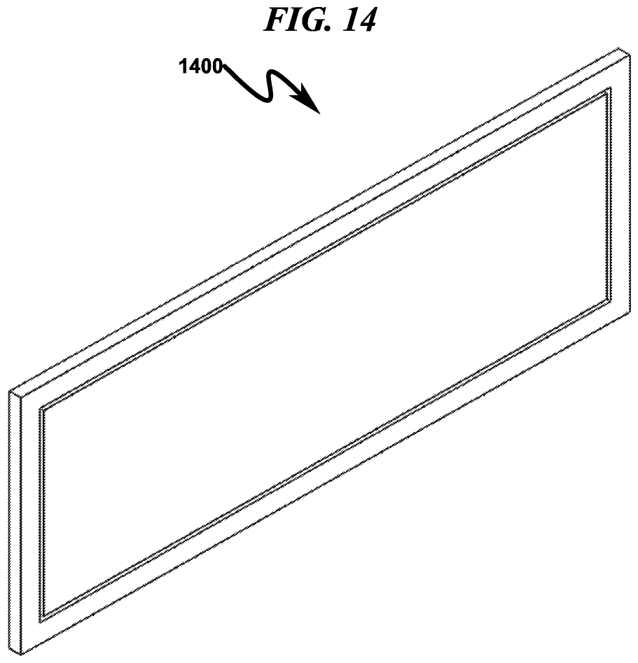

FIG. 15 illustrates a right front top perspective top sectional view of a preferred exemplary invention embodiment depicting various layers in the beverage flavor strip (BFS) incorporating overlapping FEA alternative construction with EFL and FEA omitted to show overlapping of the ESL by the FEA to allow the FEA to contact the RML;

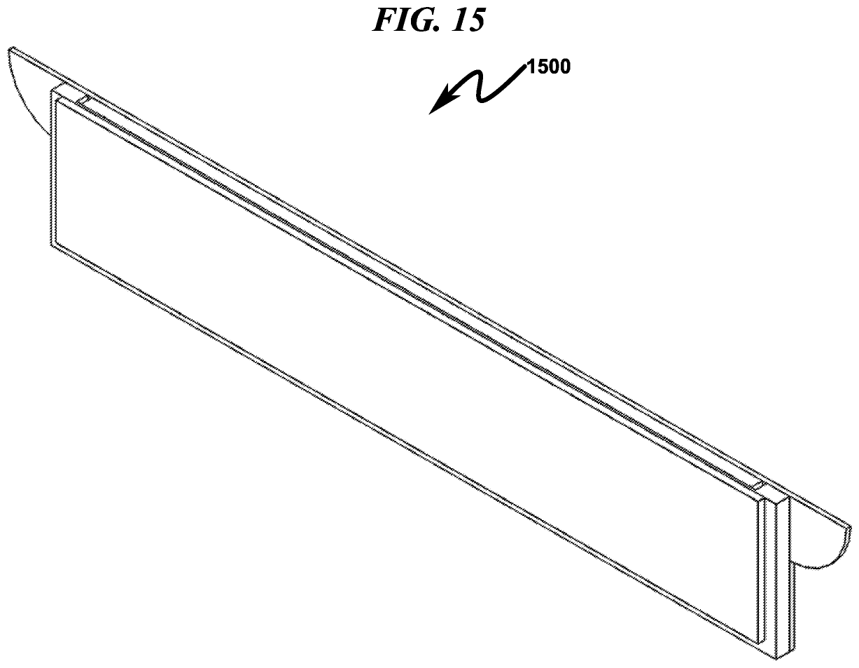

FIG. 16 illustrates a right front top perspective right side sectional view and right side section view of a preferred exemplary invention embodiment depicting various layers in the beverage flavor strip (BFS) incorporating overlapping FEA alternative construction with EFL and FEA omitted to show overlapping of the ESL by the FEA to allow the FEA to contact the RML;

FIG. 17 illustrates front and rear perspective views of a hybrid FEA preferred exemplary invention embodiment;

FIG. 18 illustrates front and rear perspective views of a hybrid FEA preferred exemplary invention embodiment with EFL and RML layers suppressed;

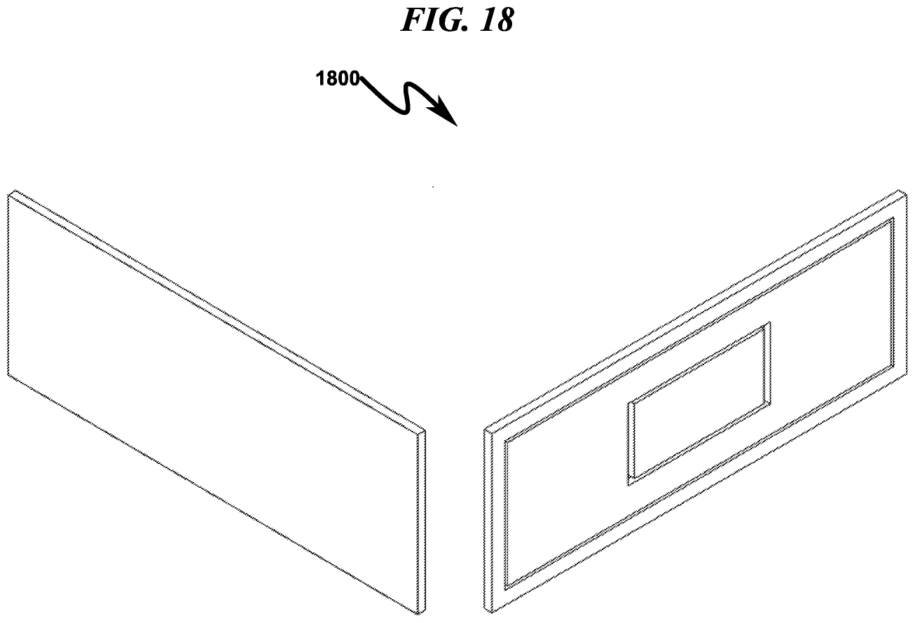

FIG. 19 illustrates front and rear perspective views of a hybrid FEA preferred exemplary invention embodiment with EFL, ESL, and RML layers suppressed;

FIG. 20 illustrates top and side perspective section views of a hybrid FEA preferred exemplary invention embodiment;

FIG. 21 illustrates a right front top perspective view of a preferred exemplary invention embodiment depicting various layers in the beverage flavor strip (BFS) incorporating a typical flavor protective layer (FPL);

FIG. 22 illustrates a right front top perspective view of a preferred exemplary invention embodiment depicting various layers in the beverage flavor strip (BFS) incorporating a typical flavor protective layer (FPL);

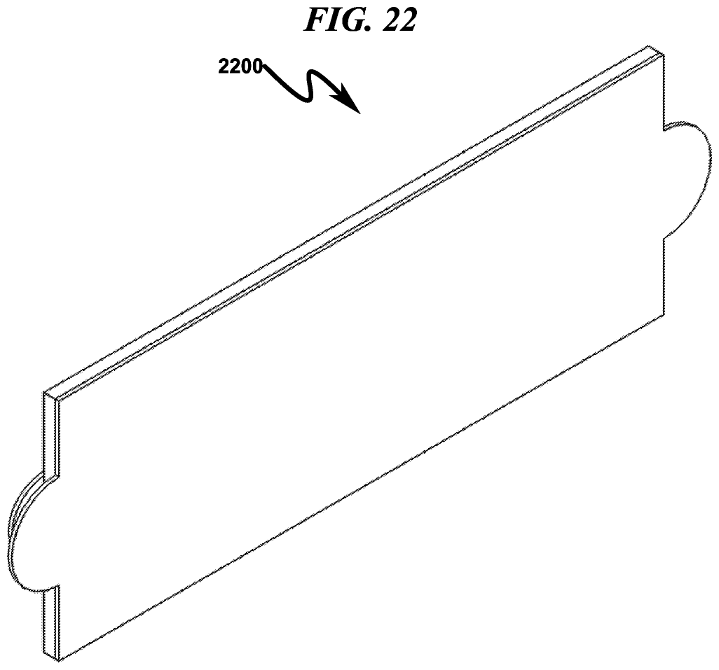

FIG. 23 illustrates a right front top perspective top sectional view of a preferred exemplary invention embodiment depicting various layers in the beverage flavor strip (BFS) incorporating a typical flavor protective layer (FPL);

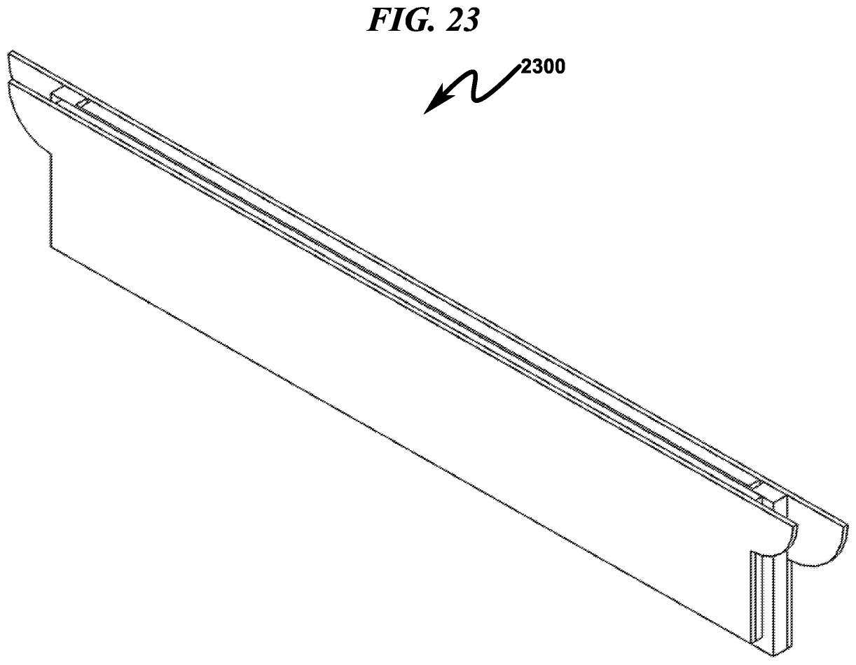

FIG. 24 illustrates a right front top perspective right side sectional view and right side section view of a preferred exemplary invention embodiment depicting various layers in the beverage flavor strip (BFS) incorporating a typical flavor protective layer (FPL);

FIG. 25 illustrates a preferred exemplary invention embodiment formed as a surface strip applied to a beverage container drinking cup;

FIG. 26 illustrates a preferred exemplary invention embodiment formed as a surface strip applied to a beverage container can;

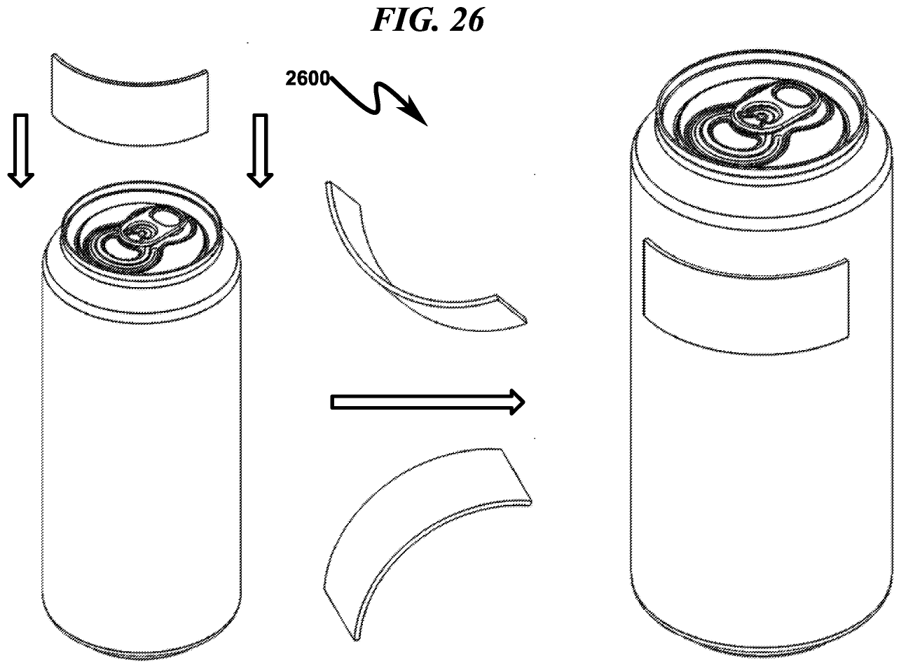

FIG. 27 illustrates a preferred exemplary invention embodiment formed as a strip applied to a beverage container bottle;

FIG. 28 illustrates a preferred exemplary invention embodiment formed as a surface patch applied to a beverage container bottle;

FIG. 29 illustrates a preferred exemplary invention embodiment formed as a cylindrical surface applied to a beverage container can;

FIG. 30 illustrates a preferred exemplary invention embodiment formed as a cylindrical strip applied to a beverage container can;

FIG. 31 illustrates a preferred exemplary invention embodiment formed as a conical surface applied to a beverage container bottle;

FIG. 32 illustrates a preferred exemplary invention embodiment formed as a conical strip applied to a beverage container bottle;

FIG. 33 illustrates front and rear perspective views of a preferred exemplary invention embodiment formed as an layered flavor strip (LFS) comprising only the EFL/FEA/ESL layers;

FIG. 34 illustrates front and rear perspective views of a preferred exemplary invention embodiment formed as an layered flavor strip (LFS) comprising only the EFL/FEA/ESL layers with the ESL layer removed;

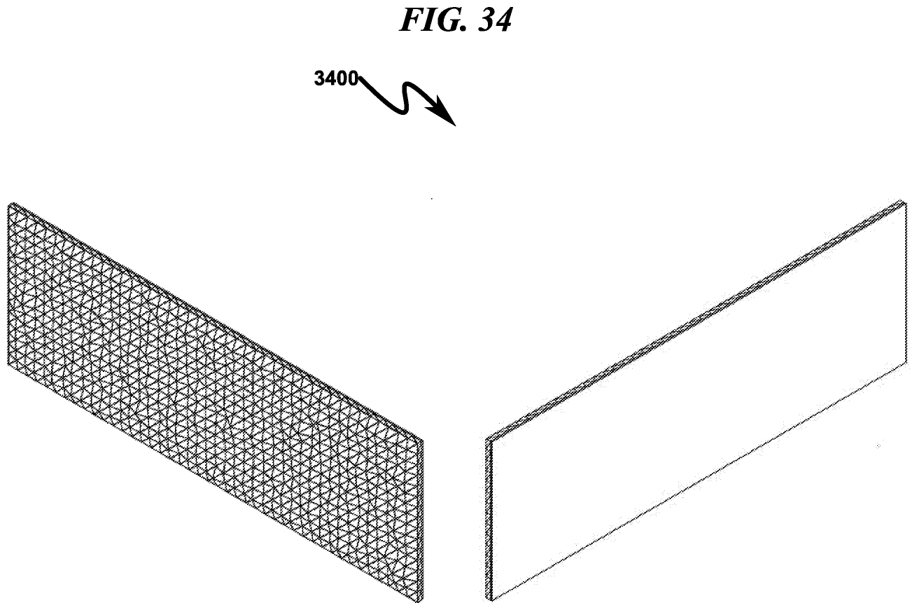

FIG. 35 illustrates front and rear perspective views of a preferred exemplary invention embodiment formed as an layered flavor strip (LFS) comprising only the EFL/FEA/ESL layers with the EFL layer removed;

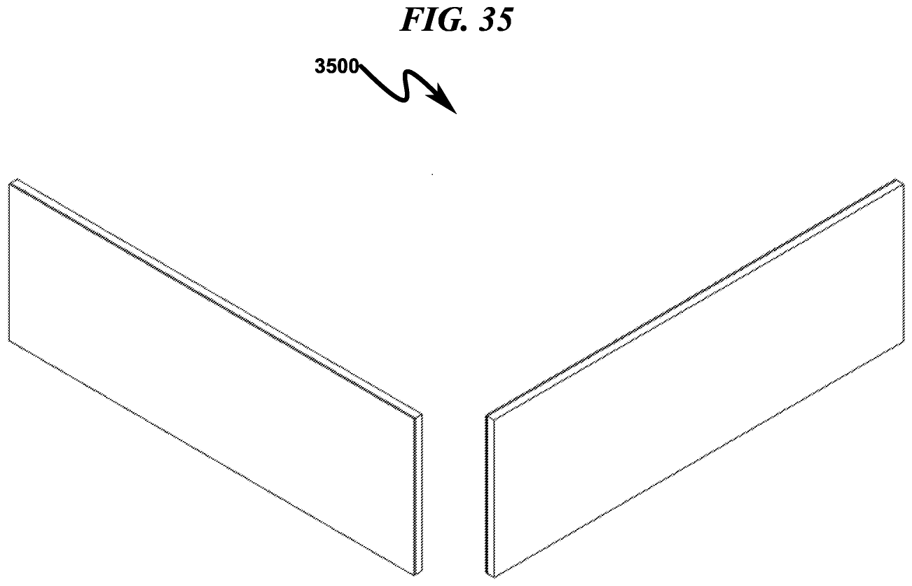

FIG. 36 illustrates front and rear perspective views of a preferred exemplary invention embodiment formed as an layered flavor strip (LFS) comprising only the EFL/FEA/ESL layers with the ESL and FEA layers removed;

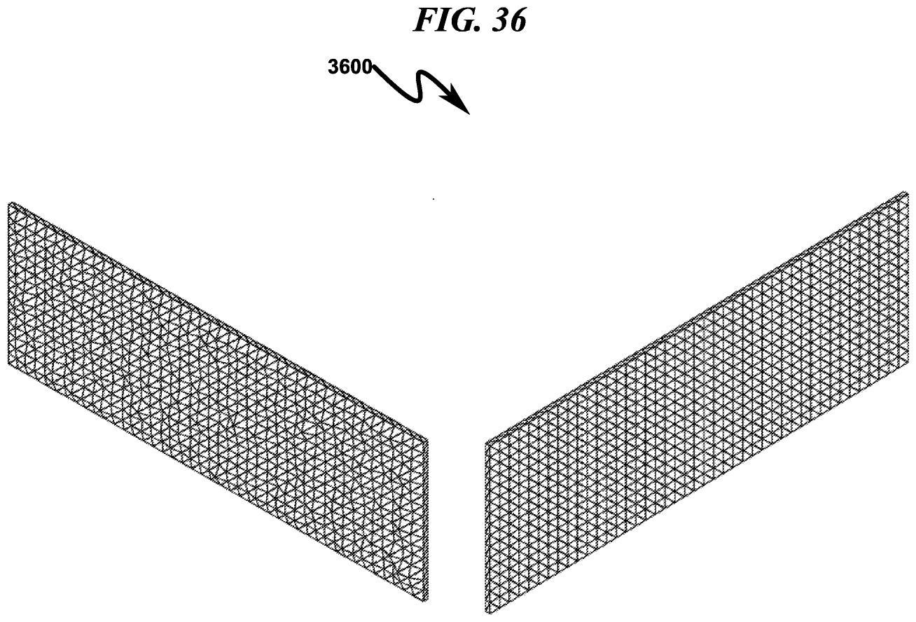

FIG. 37 illustrates a top view of a preferred exemplary invention embodiment formed as an layered flavor strip (LFS) comprising only the EFL/FEA/ESL layers;

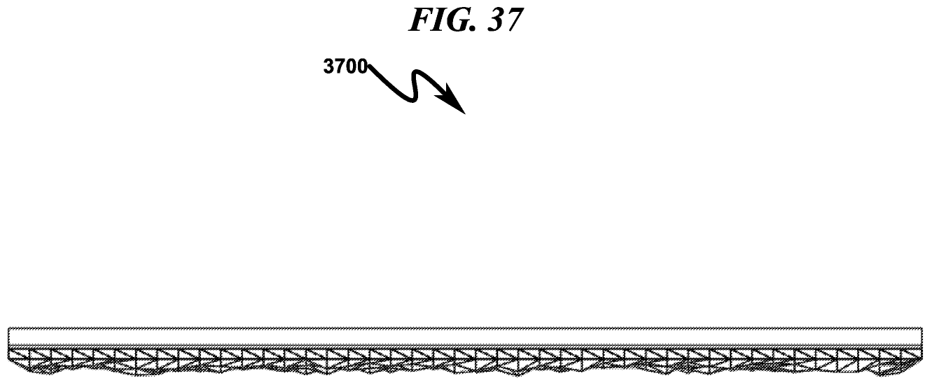

FIG. 38 illustrates a side view of a preferred exemplary invention embodiment formed as an layered flavor strip (LFS) comprising only the EFL/FEA/ESL layers;

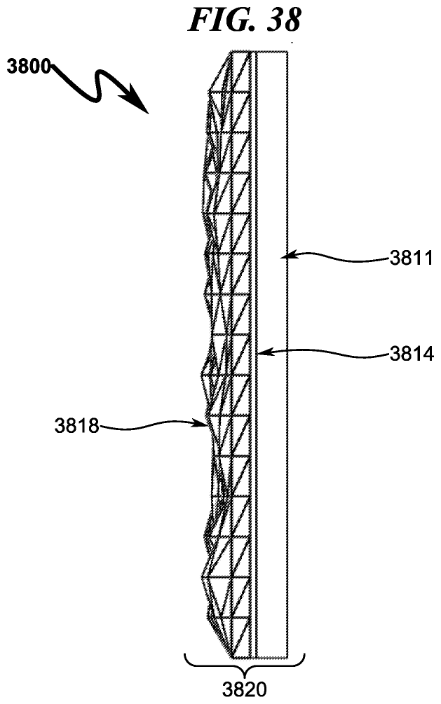

FIG. 39 illustrates front and rear perspective views of a preferred exemplary invention embodiment formed as an layered flavor strip (LFS) comprising only the EFL/FEA/ESL layers with protective packaging envelope (PPE) enclosing the layered flavor strip (LFS); and

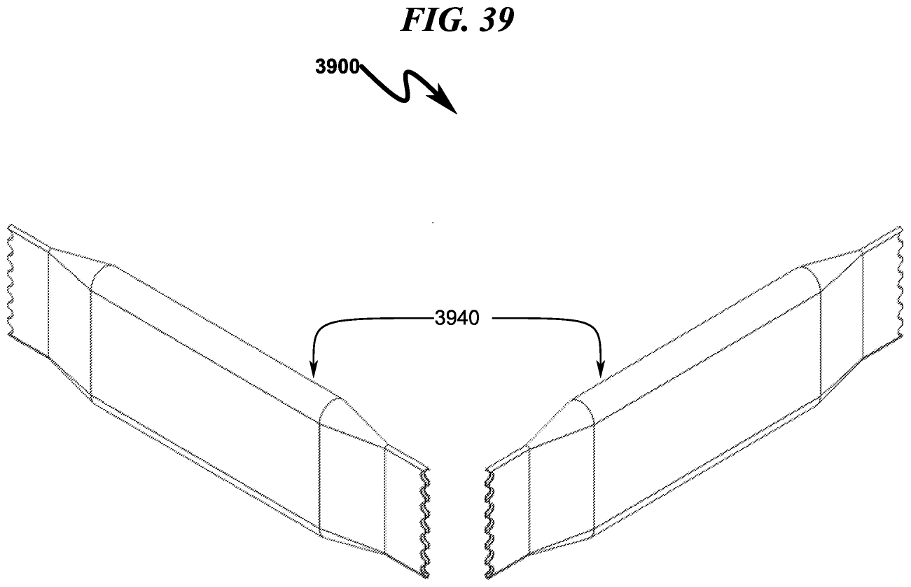

FIG. 40 illustrates top and side perspective views of a preferred exemplary invention embodiment formed as an layered flavor strip (LFS) comprising only the EFL/FEA/ESL layers with protective packaging envelope (PPE) enclosing the layered flavor strip (LFS).

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a BEVERAGE FLAVOR STRIP SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Materials Not Limitive

While preferred materials for elements of the present invention will herein be described, the present invention is not limited by these materials. Gelatin, sugar, water, salt, citrus flavoring, sugar, parchment paper, and other materials may comprise some or all of the elements of the present invention.

### Construction Not Limitive

Various preferred exemplary embodiments are illustrated herein to teach the present invention. However, elements and features of each preferred exemplary embodiment may be combined with other depicted (and non-depicted) preferred exemplary embodiments to produce other preferred exemplary embodiments that may or may not be illustrated herein. Thus, the features depicted herein may be combined with others to form a wide variety of preferred exemplary embodiments as will be well understood by one skilled in the art.

### Beverage Container Not Limitive

The term “beverage container” or “BC” should be given a broad interpretation when limiting the scope of the present invention. A beverage container (BC) in this context may typically include conventional bottles, cans, and other instruments in which beverages may be dispensed. However, other devices for beverage containment may include glasses, goblets, and other drinking style cups and the like that may be used to typically contain beverages and other liquids. Within any of these contexts the present invention may be applied after the BC is manufactured or in some circumstances may be integrated into the manufacture of the device such that after-application is not required.

### Dimensions Not Limitive

The present invention will be presented herein schematically in general terms. Specific sizes and dimensions as shown are only illustrative and do not limit the scope of the claimed invention. Specific relative sizes of various elements are shown for clarity and may not represent actual construction techniques used when reducing the invention to practice.

### Flavoring Not Limitive

The flavoring used within the edible flavoring layer (EFL) described herein may take many forms, including but not limited to citrus flavoring, one or more spices (including but not limited to chili lime, pickle flavor, hot lime flavor, etc.), and one or more sugar flavors (including but not limited to peach, strawberry, fruit, etc.). One skilled in the art will recognize that this list is non-exhaustive and may be substituted with any specific flavoring as required by application context.

### Citrus Flavoring Not Limitive

The term “citrus flavoring” should be given an interpretation to include a broad range of flavors to include but not be limited to lemon, lime, orange, and other like flavors.

### Salt Not Limitive

The term “salt” used herein should be given a broad scope. While normal table salt (sodium chloride) may be used in many preferred embodiments, other salts may be used in a variety of other application contexts.

### System Overview (0100)

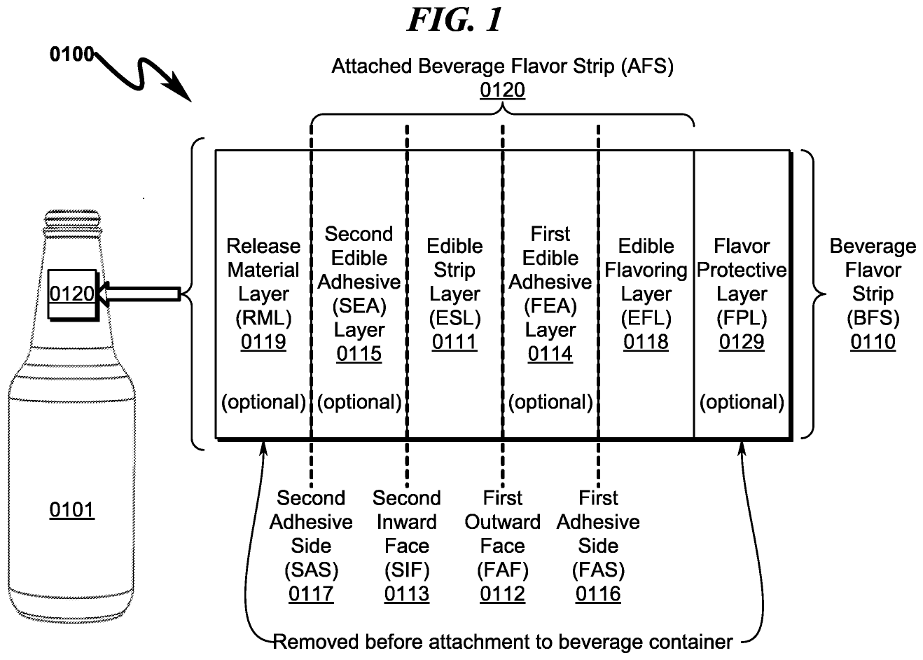

A block diagram of a preferred invention system embodiment is generally depicted in FIG. 1 (0100). Here it can be seen that a beverage container (0101) is affixed with a beverage flavor strip (BFS) (0110) after removal of a release material layer (RML) (0119) to form an attached beverage flavor strip (AFS) (0120). The BFS (0110) consists of an edible strip layer (ESL) (0111) having a first outward face (FOF) (0112) and a second inward face (SIF) (0113) that mate with respective first edible adhesive (FEA) layer (0114) and second edible adhesive (SEA) layer (0115) on either side of the edible strip layer (ESL) (0111).

The first edible adhesive (FEA) layer (0114) includes a first adhesive side (FAS) (0116) and the second edible adhesive (SEA) layer (0115) includes a second adhesive side (SAS) (0117) that mate respectively to an edible flavoring layer (EFL) (0118) layer and a release material layer (RML) (0119). The release material layer (RML) (0119) is configured to be removed or peeled back from the SEA (0115) to allow the SEA (0115) attach (0120) to a beverage container (BC) (0101). The attached beverage flavor strip (AFS) (0120) may be applied either at the point the BC (0101) is manufactured/filled or any time later in the delivery chain to the ultimate beverage consumer. The beverage consumer may also manually apply the attached beverage flavor strip (AFS) (0120) just prior to consumption of the beverage.

Depending on the application context and invention configuration, the first edible adhesive (FEA) layer (0114), second edible adhesive (SEA) layer (0115), and/or release material layer (RML) (0119) may omitted from the configuration. In these situations the edible strip layer (ESL) (0111) may incorporate sufficient tackiness (due to sugar content or other material content) to provide adhesion to the BC (0101) and/or edible flavoring layer (EFL) (0118). A secondary release material layer (RML) (0119) may be optionally applied to the EFL (0118) and termed herein as a flavor protective layer (FPL) (0129) used to protect the EFL (0118) from contamination.

### Method Overview (0200)

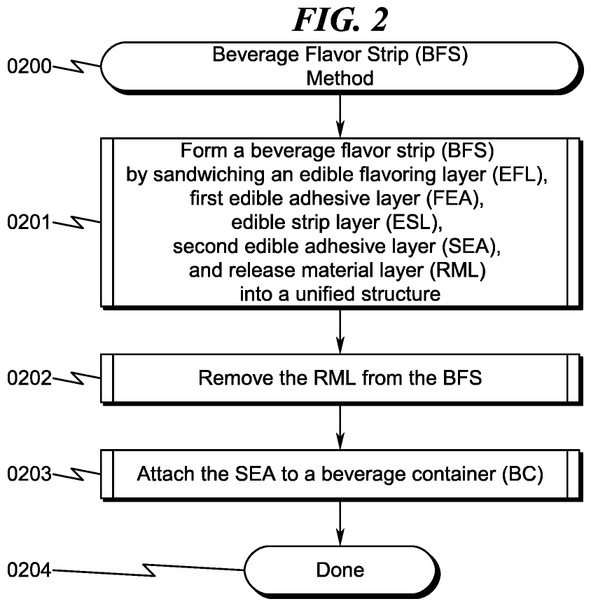

This present invention setup method anticipates a wide variety of variations in the basic theme of implementation, but can be generalized as depicted in FIG. 2 (0200) as a beverage flavor strip method comprising:
(1) Form a beverage flavor strip (BFS) by sandwiching an edible flavoring layer (EFL), first edible adhesive layer (FEA), edible strip layer (ESL), second edible adhesive layer (SEA), and release material layer (RML) into a unified structure (0201);
(2) Remove the RML from the BFS (0202); and
(3) Attach the SEA to a beverage container (BC) (0203).
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention. This and other methods described herein are optimally executed under control of a computer system reading instructions from a computer readable media as described elsewhere herein.

### Typical Construction (0300)-(0800)

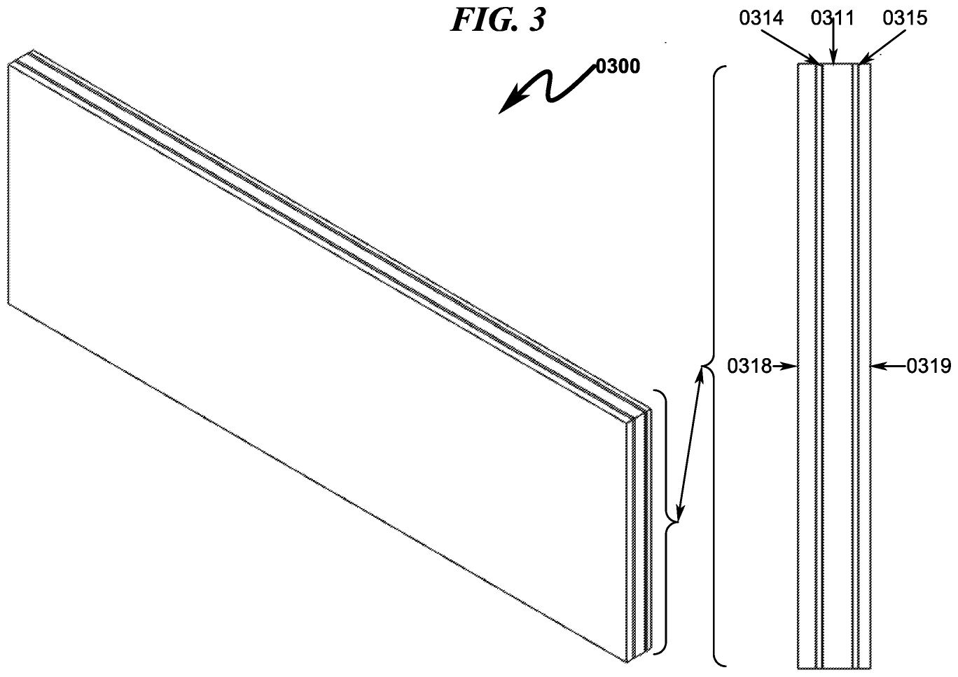

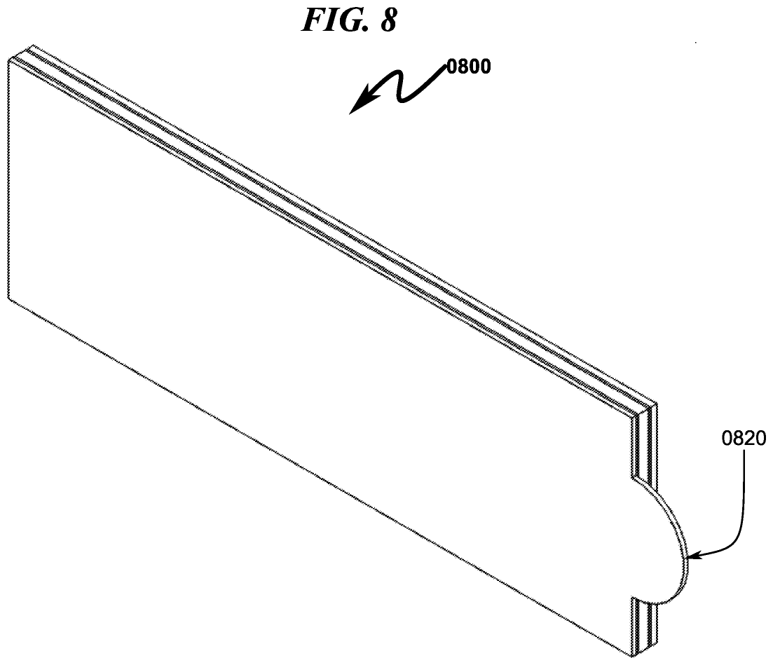

FIG. 3 (0300)-FIG. 8 (0800) depict various layers in the present invention. These figures depict front and rear perspective and sectional perspective views of the elements of the edible flavored strip that adheres to handheld beverage containers (the “strip”) according to various embodiments of the present invention. The edible strip layer (ESL) (0311, 0611) is generally comprised of an edible substance. More particularly the edible strip layer (ESL) (0311, 0611) is comprised of gelatin, sugar, and water. The edible flavoring layer (EFL) (0318, 0618) substance is generally comprised of various flavors. More particularly the edible flavoring layer (EFL) (0318, 0618) generally consists of salt and/or sugar and/or spices. The edible flavoring layer (EFL) (0318, 0618) is adhered to the edible strip layer (ESL) (0311, 0611) using the first edible adhesive layer (FEA) (0314, 0614). The first edible adhesive (FEA) layer (0314, 0614) is generally comprised of an edible sticky substance. More particularly the first edible adhesive (FEA) layer (0314, 0614) is generally comprised of corn syrup and water.

The edible strip layer (ESL) (0311, 0611) is generally comprised of an edible substance. More particularly the edible strip layer (ESL) (0311, 0611) is comprised of gelatin, sugar, and water but may also be comprised of glucose syrup, sugar, and wheat flour. The release material layer (RML) (0319, 0619) serves as a protective layer covering the second edible adhesive (SEA) (0315, 0615) layer on the back of the strip and is generally comprised of a paper or plastic like material. More particular the release material layer (RML) (0319, 0619) may be typically comprised of silicone parchment paper. When the release material layer (RML) (0319, 0619) is removed the second edible adhesive (SEA) (0315, 0615) layer is used to place the edible strip layer (ESL) (0311, 0611) on a handheld beverage container.

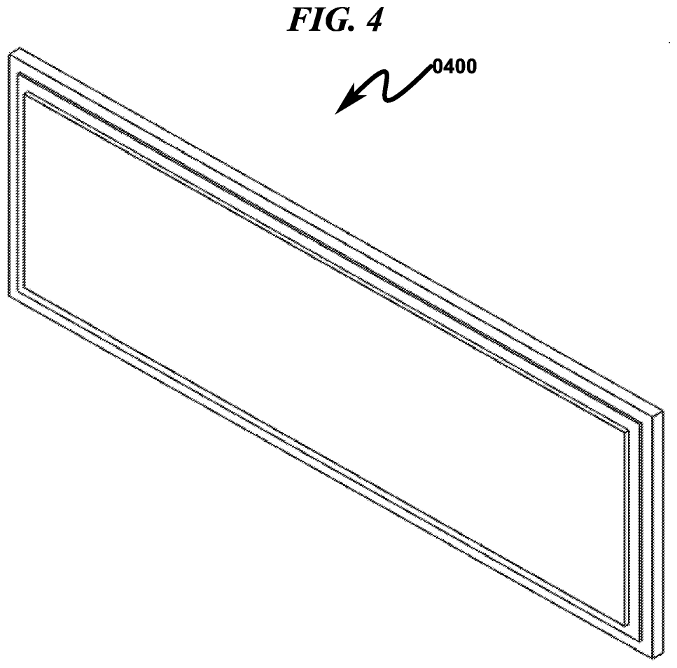

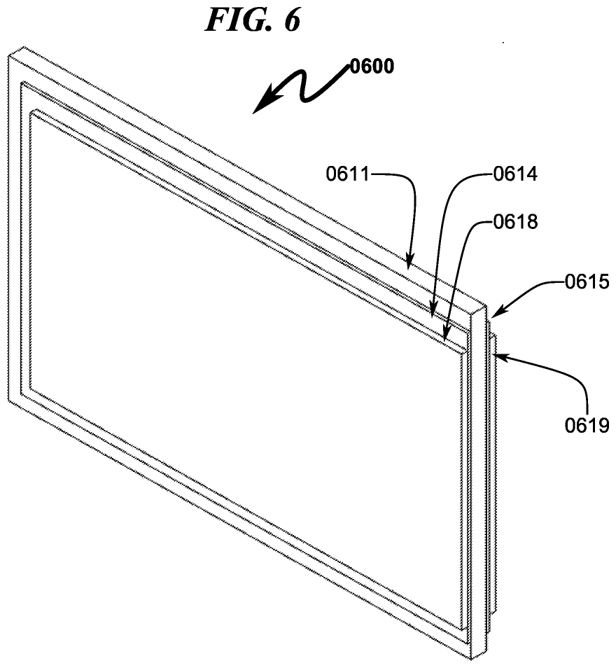

FIG. 4 (0400)-FIG. 6 (0600) depict the various layers of the invention having different surface areas so as to allow a clearer depiction of their relative stacking order. The edible strip layer (ESL) (0319, 0619) is shown with the first edible adhesive layer (FEA) (0314, 0614) and second edible adhesive layer (SEA) (0315, 0615) on both sides of the edible strip layer (ESL) (0311, 0611) and the edible flavoring layer (EFL) (0318, 0618) adhered on one side with the release material (0319, 0619) adhered on the other side. The release material layer (RML) (0319, 0619) is removed and the edible strip layer (ESL) (0311, 0611) is placed on a handheld beverage using the second edible adhesive layer (SEA) (0315, 0615) to adhere to it. The edible flavoring layer (EFL) (0318, 0618) substance is adhered to the edible strip layer (ESL) (0311, 0611) using the first edible adhesive (FEA) (0314, 0614) layer.

Some preferred invention embodiments may incorporate a release material tab (RMT) (0720, 0820) that permits the release material layer (RML) (0319, 0619) to be easily removed from the second edible adhesive layer (SEA) (0315, 0615) on which it is placed prior to the attachment of the edible strip layer (ESL) (0311, 0611) to a beverage container.

### Projected FEA Alternative Construction (0900)-(1200)

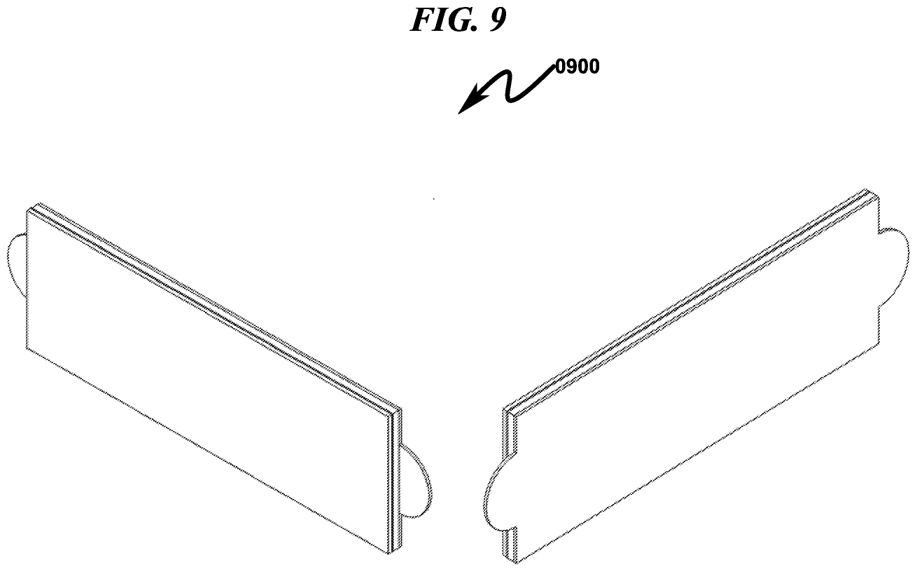

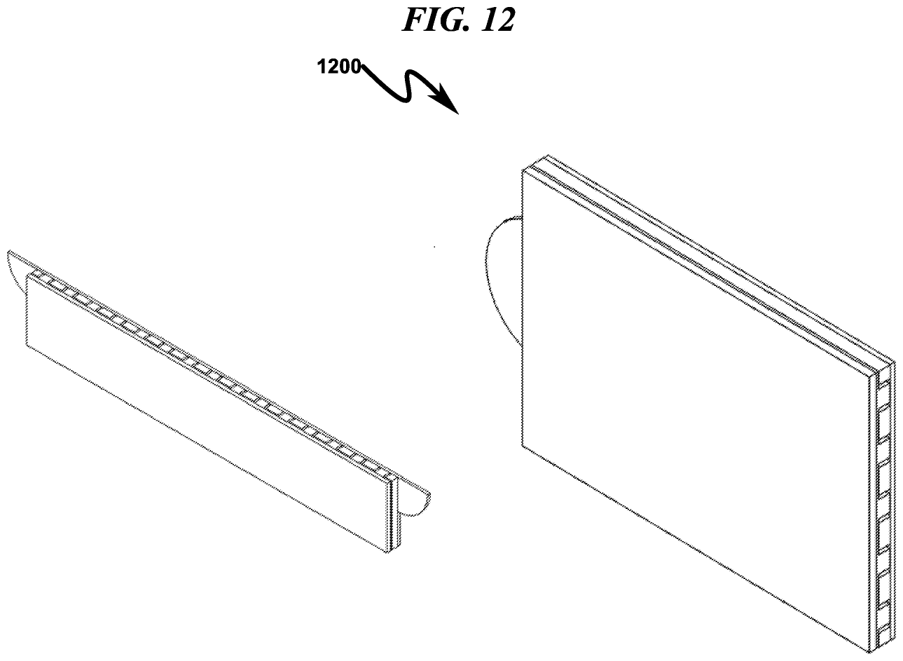

An alternative projected FEA construction technique for some preferred invention embodiments is generally illustrated in FIG. 9 (0900)-FIG. 12 (1200) wherein the second edible adhesive layer (SEA) is eliminated and instead the first edible adhesive layer (FEA) (1114) is projected (1424) through the edible strip layer (ESL) (1011) via a plurality of perforations (1021) in the ESL (1011) from the contact plane of the FEA layer. Perforations within the ESL permit the FEA to flow through to the plane of the RML and perform two functions. First, the FEA provides temporary fixation of the RML to the ESL. Second, once the RML is removed from the ESL the projected FEA material permits adhesion to the beverage container by providing contact with plurality of FEA projections.

### Overlapping FEA Alternative Construction (1300)-(1600)

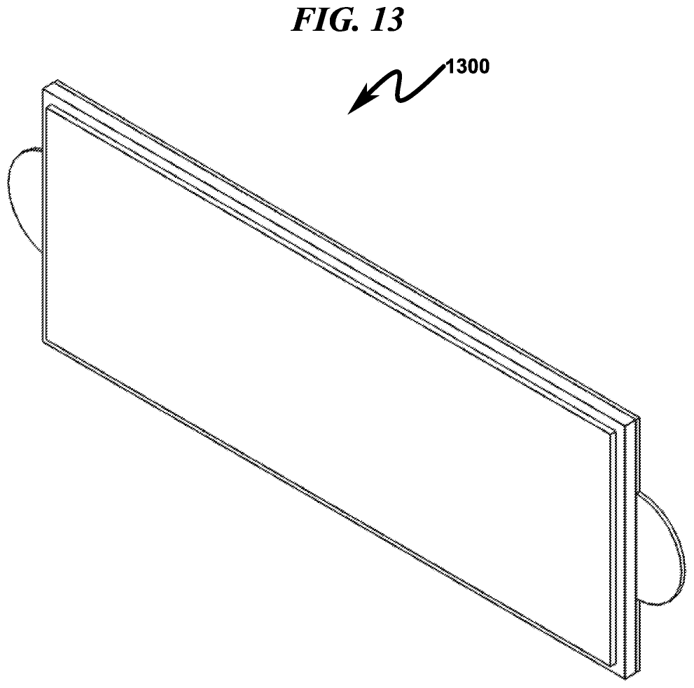

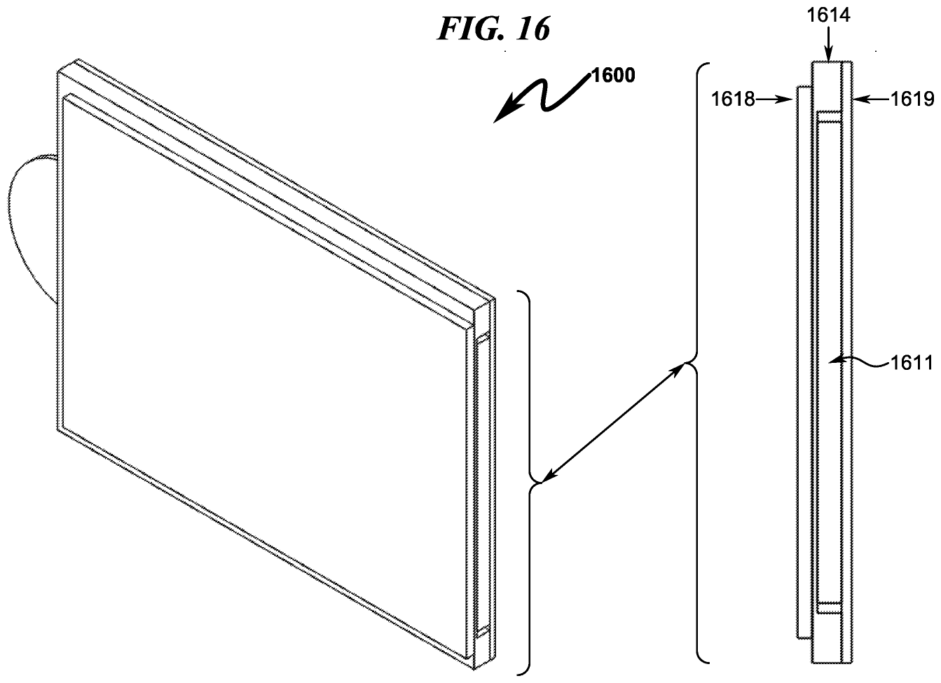

An alternative overlapping FEA construction technique for some preferred invention embodiments is generally illustrated in FIG. 13 (1300)-FIG. 16 (1600) wherein the second edible adhesive layer (SEA) is eliminated and instead the first edible adhesive layer (FEA) (1614) is overlapped around the edges of the edible strip layer (ESL) (1611). This overlap allows the release material layer (RML) (1619) to contact the FEA (1614) around the edges of the ESL (1611). Once the RML (1619) is removed, the FEA (1614) attaches to the beverage container and thus affixes the ESL (1611) and EFL (1618) to the beverage container.

### Hybrid FEA Alternative Construction (1700)-(2000)

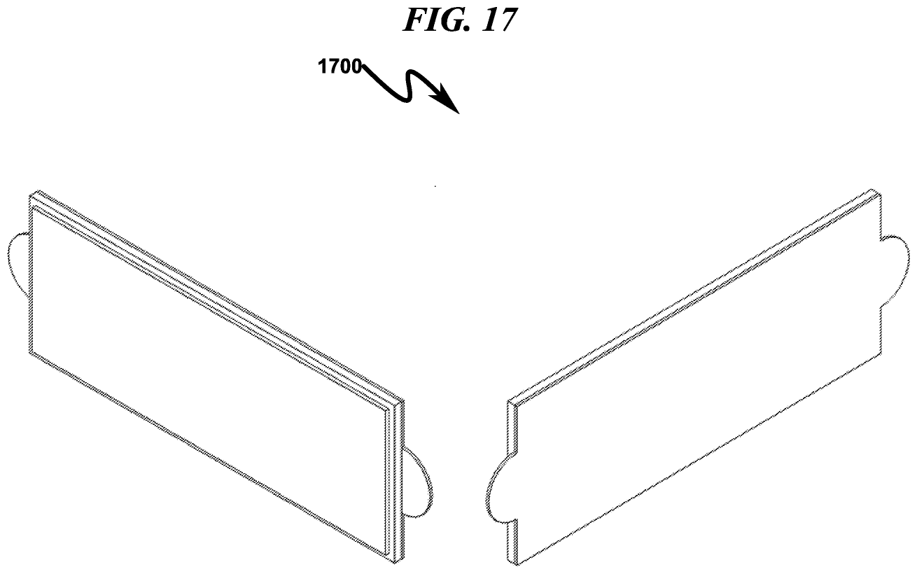

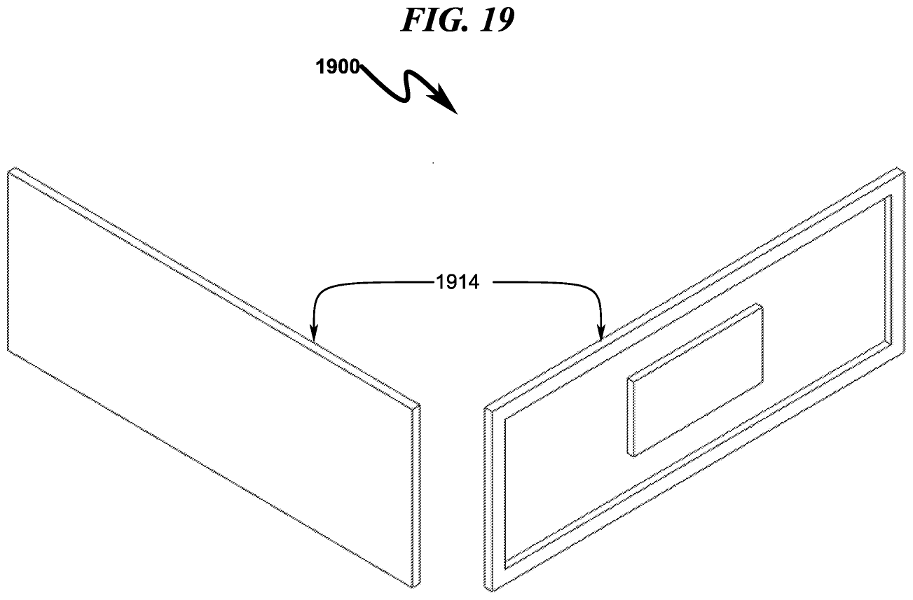

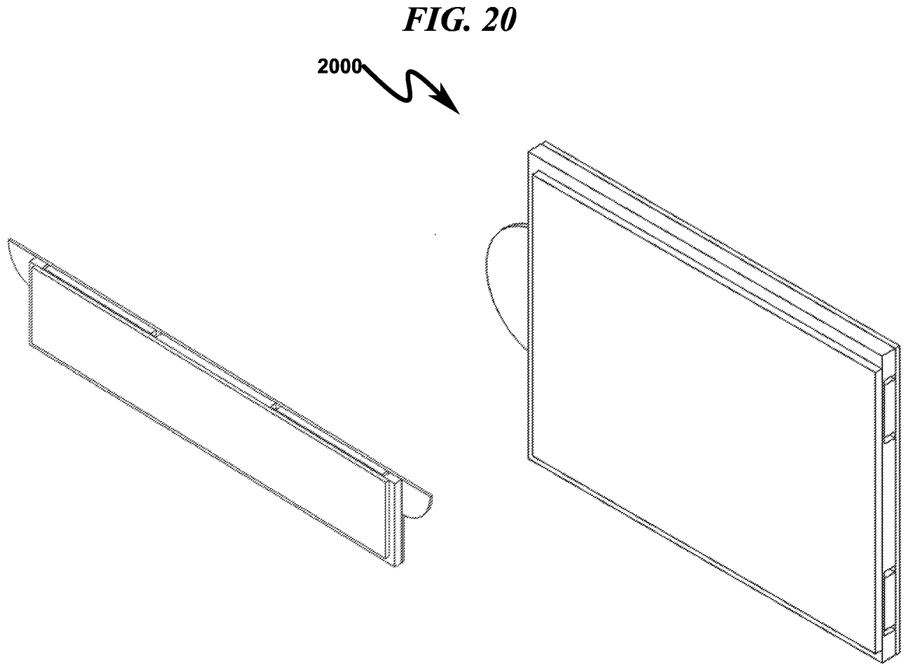

As depicted in FIG. 17 (1700)-FIG. 20 (2000), it is possible to produce a hybrid construction of FEA projection and overlapped FEA. As can be seen by the FEA layer (1914) in isolation in FIG. 19 (1900), there may be one or more projections of the FEA (1914) through the ESL in conjunction with the overlap of the ESL by the FEA to accommodate attachment of the ESL and EFL to the beverage container once the RNL is removed. While only one projection of the FEA (1914) through the ESL is shown in this illustration, any number of projections may be formed in various embodiments based on application context.

### Flavor Protective Layer (FPL) (2100)-(2400)

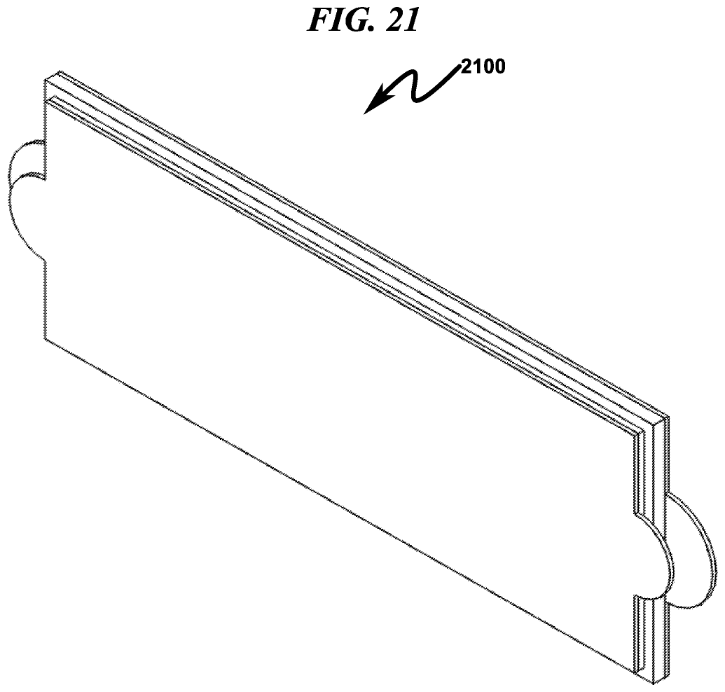

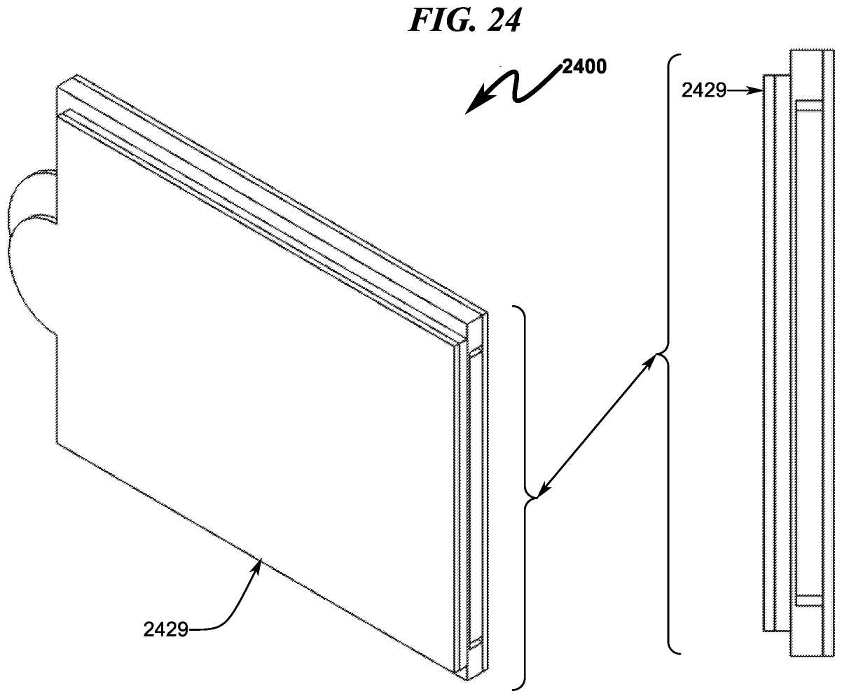

As generally illustrated in FIG. 1 (0100) and FIG. 21 (2100)-FIG. 24 (2400), the present invention anticipates that a secondary release material layer (RML) may be applied to the EFL and termed herein as a flavor protective layer (FPL) (0129, 2429). This additional protective layer for the EFL serves to protect the EFL from contamination prior to application of the BFS to the beverage container. As depicted in these drawings, the FPL (2429) may include a removal tab similar in construction that provided for with the RML. The construction of the FPL may take the same form as that of the RML or it may be constructed of a different material consistent with protection of and/or identification of the EFL.

### Typical Application Context (2500)-(3200)

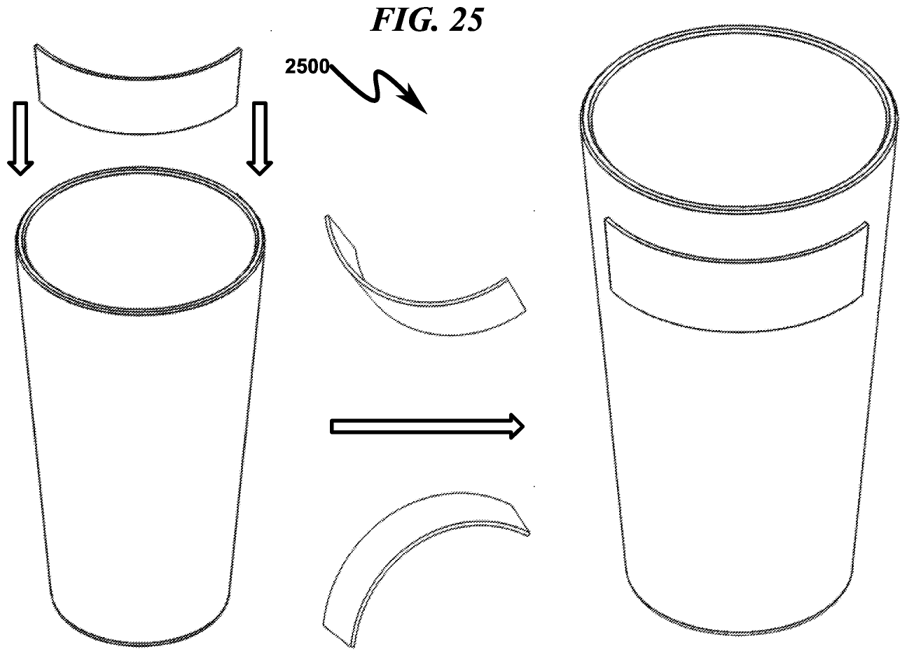

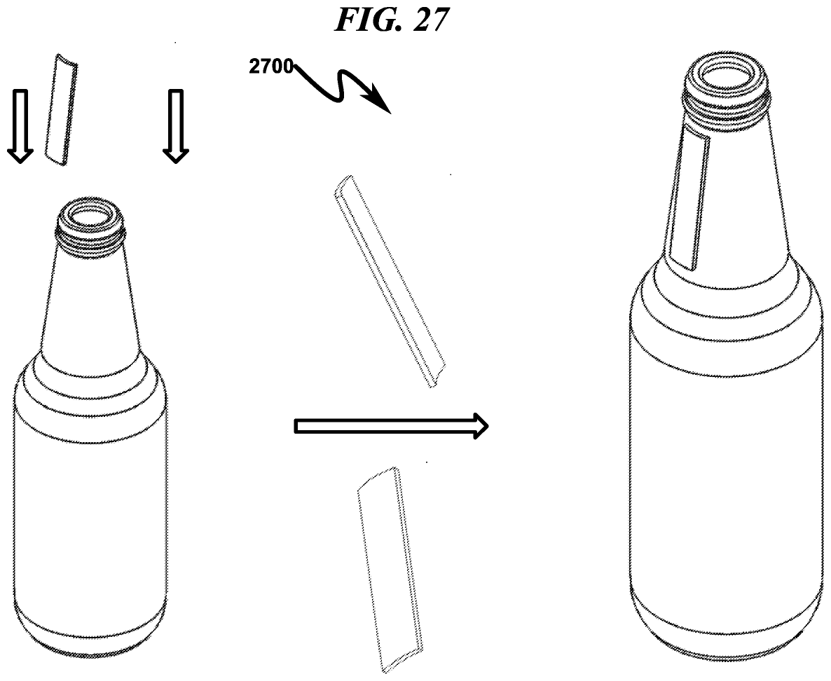

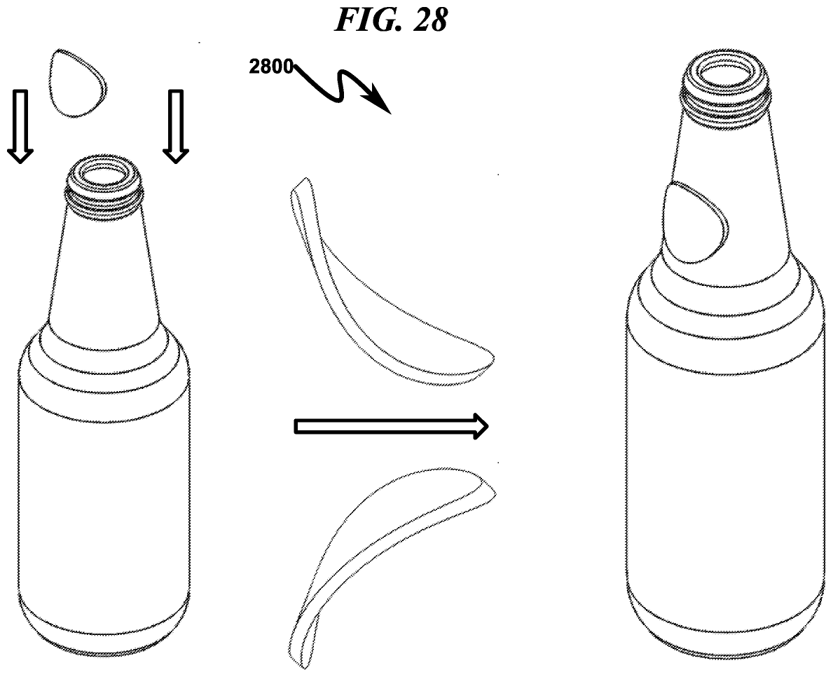

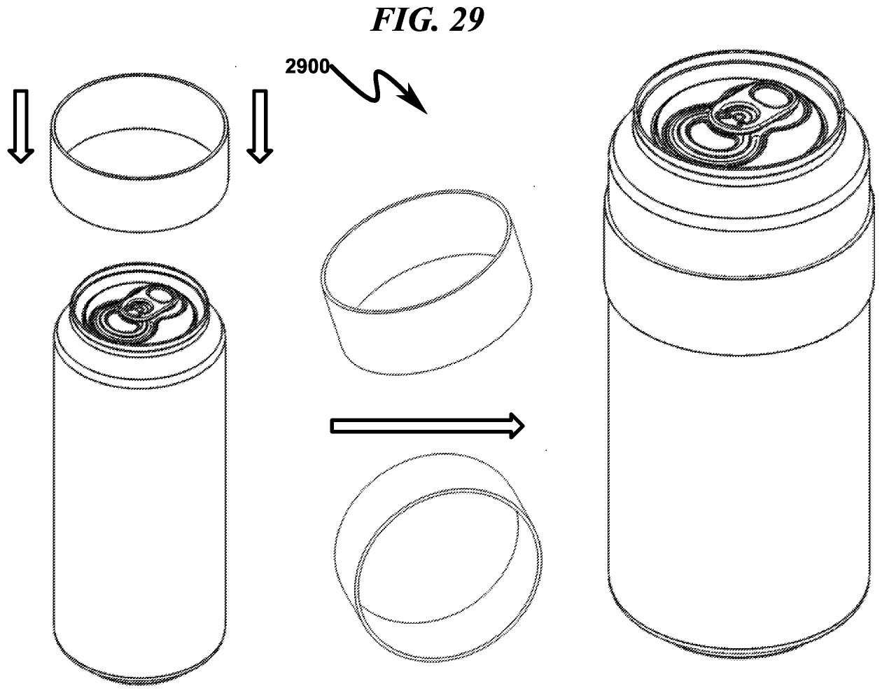

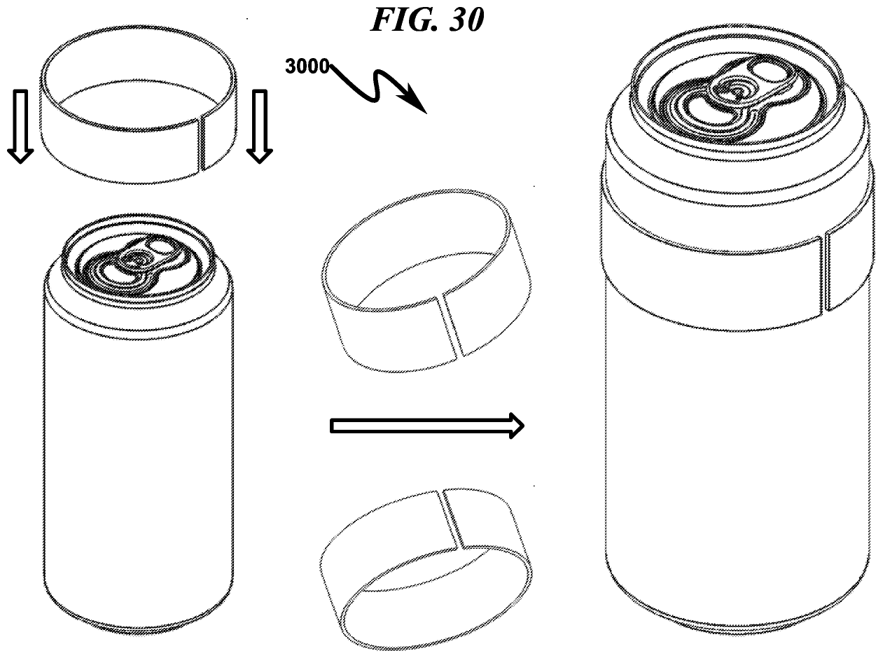

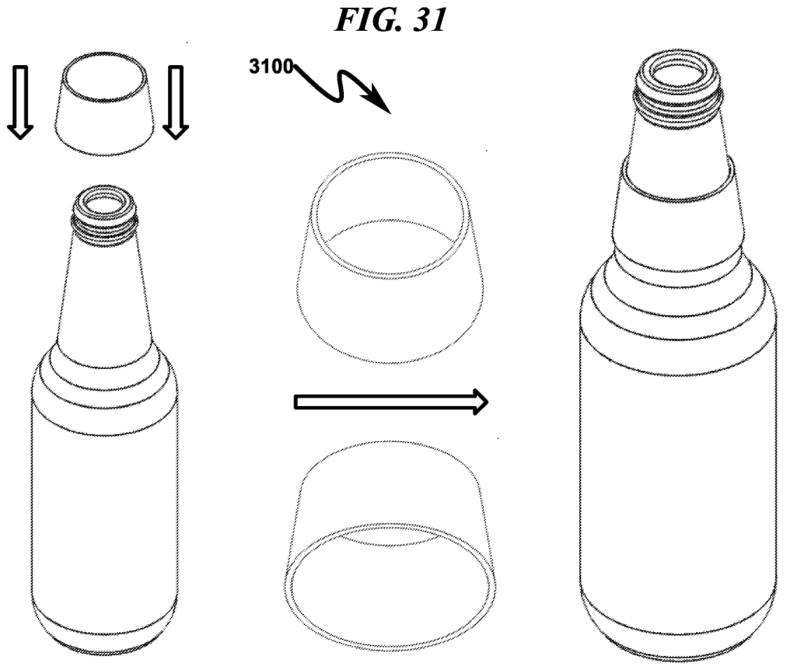

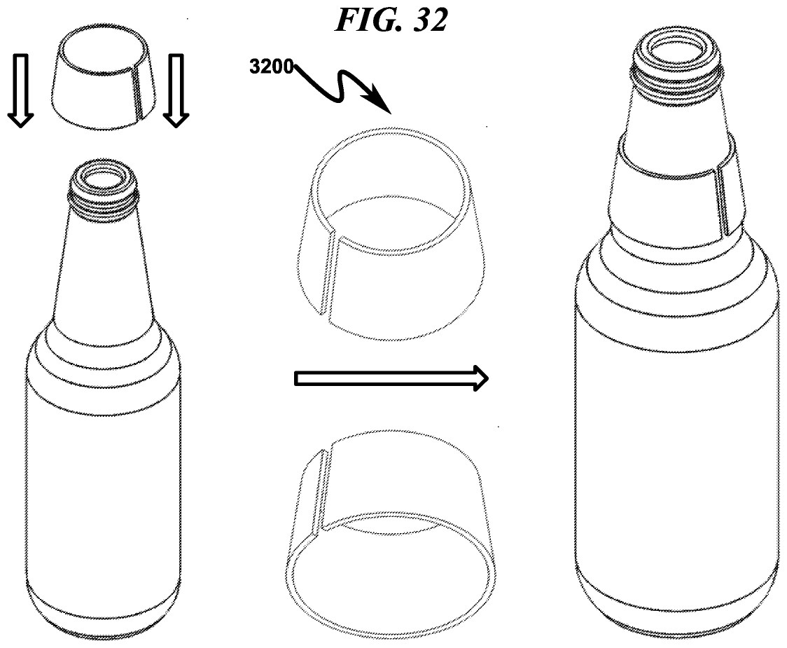

FIG. 25 (2500)-FIG. 32 (3200) depict various preferred exemplary embodiments of the present invention as applied in various stages to a variety of beverage containers. Note that in these depictions the BFS may be formed using a wide variety of construction techniques. While a strip (FIG. 25 (2500)-FIG. 27 (2700)), patch (FIG. 28 (2800)), cylindrical (FIG. 29 (2900)-FIG. 30 (3000)), and conical (FIG. 31 (3100)-FIG. 32 (3200)) forms are illustrated in these drawings, the scope of the present invention is not limited to these forms. As indicated previously, the BFS may be applied at the time of beverage manufacture/container filling or after the fact prior to consumption of the beverage by the consumer.

### Alternative Application Context (3300)-(4000)

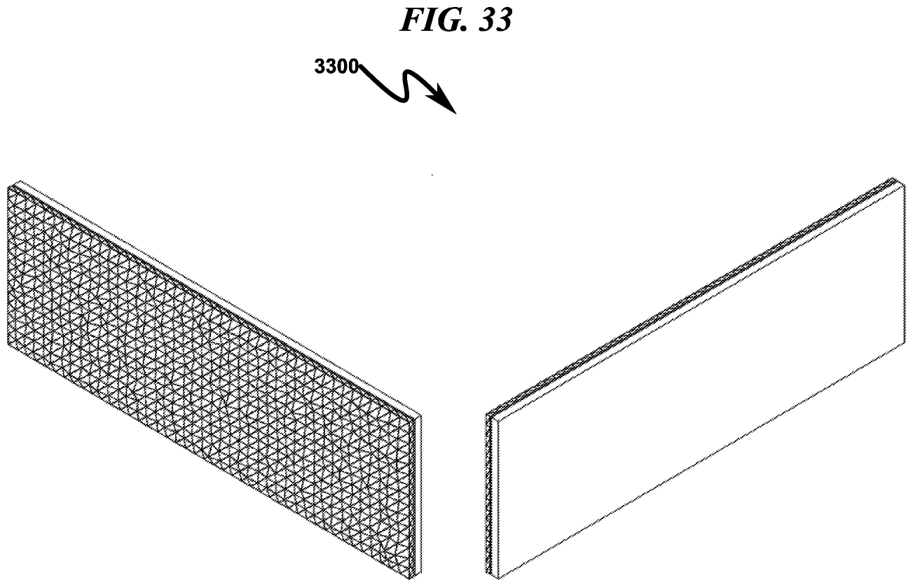

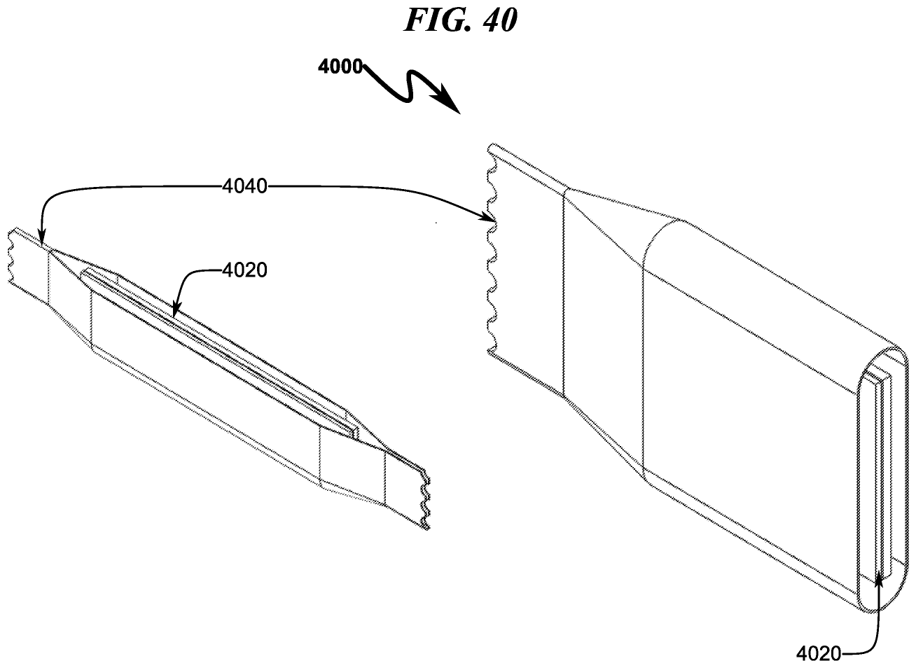

In some circumstances as generally depicted in FIG. 33 (3300)-FIG. 40 (4000), the release material layer (RML) may be substituted by the use of a protective packaging envelope (PPE) (3940, 4040) that encases and provides for a hermetic seal surrounding the layered flavor strip (LFS) (3820, 4020) comprising the EFL (3818)/FEA (3814)/ESL (3811) layers. Here the SEA layer is not required as the ESL (3811) may be moistened just prior to attachment to the beverage container (BC) to provide the required adhesion between the EFL (3818)/FEA (3814)/ESL (3811) combination and the beverage container (BC). As depicted in these drawings, the EFL (3818) may be comprised of a granular flavoring (including but not limited to a salt) that may provide a texture to the outer surface of the layered flavor strip (LFS) (3820) as it is applied to the beverage container. The protective packaging envelope (PPE) (3940, 4040) as depicted may take many material forms including those known to one skilled in the art of packaging foodstuffs and other edible products. As depicted, the packaging may include a variety of methods by which the packaging can be torn to expose the layered flavor strip (LFS) (3820, 4020).

It should be noted that in some preferred embodiments the FEA (3814) may be omitted and the EFL (3818) may be attached directly to the ESL (3811) in which case the sugar, glucose, or other material in the ESL (3811) may be used to bind elements of the EFL (3818) directly to the ESL (3811) without the need for an additional binding agent.

### System Summary

The present invention system may be broadly generalized as a beverage flavor strip (BFS) system comprising:
(a) edible flavoring layer (EFL);
(b) first edible adhesive layer (FEA);
(c) edible strip layer (ESL);
(d) second edible adhesive layer (SEA); and
(e) release material layer (RML);
wherein:
the ESL comprises a first outward face (FOF) and a second inward face (SIF);
the FOF is coated with the FEA to form a first adhesive side (FAS);
the SIF is coated with an SEA that form a second adhesive side (SAS);
the FAS is coated with the EFL;
the SAS is coated with the RML; and
the RML is configured to be removed from the SEA to allow attachment of the SEA to a beverage container (BC) with the EFL exposed for access by a beverage consumer for flavor enhancement of a beverage in the BC by the beverage consumer.

This general system summary may be augmented by the various elements described herein to produce a wide variety of invention embodiments consistent with this overall design description.

### Alternative System Summary

An alternative present invention system may be broadly generalized as a beverage flavor strip (BFS) system comprising:
(a) edible flavoring layer (EFL);
(b) first edible adhesive layer (FEA);
(c) edible strip layer (ESL); and
(d) protective packaging envelope (PPE);
wherein:
the ESL comprises a first outward face (FOF) and a second inward face (SIF);
the FOF is coated with the FEA to form a first adhesive side (FAS);
the FAS is coated with the EFL;
the ESL, the FEA, and the EFL are configured to form a layered flavor strip (LFS);
the PPE forms a hermetically sealed envelope having an internal retention cavity (IRC) of sufficient volume to contain the LFS; and
the LFS is contained within the IRC.

This general system summary may be augmented by the various elements described herein to produce a wide variety of invention embodiments consistent with this overall design description.

### Alternative ESL Binding System Summary

An alternative present invention system not requiring the FEA and using the ESL as a binding agent may be broadly generalized as a beverage flavor strip (BFS) system comprising:
(a) edible flavoring layer (EFL);
(b) edible strip layer (ESL); and
(c) protective packaging envelope (PPE);
wherein:
the ESL comprises a first outward face (FOF) and a second inward face (SIF);
the FOF is coated with the EFL;
the ESL and the EFL are configured to form a layered flavor strip (LFS);
the PPE forms a hermetically sealed envelope having an internal retention cavity (IRC) of sufficient volume to contain the LFS; and
the LFS is contained within the IRC.

This general system summary may be augmented by the various elements described herein to produce a wide variety of invention embodiments consistent with this overall design description.

### Method Summary

The present invention method may be broadly generalized as a beverage flavor strip (BFS) method comprising:
(1) forming a beverage flavor strip (BFS) by sandwiching an edible flavoring layer (EFL), first edible adhesive layer (FEA), edible strip layer (ESL), second edible adhesive layer (SEA), and release material layer (RML) into a unified structure;
(2) removing the RML from the BFS; and
(3) attaching the SEA to a beverage container (BC);
wherein:
the ESL comprises a first outward face (FOF) and a second inward face (SIF);
the FOF is coated with the FEA to form a first adhesive side (FAS);
the SIF is coated with an SEA that form a second adhesive side (SAS);
the FAS is coated with the EFL;
the SAS is coated with the RML; and
the RML is configured to be removed from the SEA to allow attachment of the SEA to the beverage container (BC) with the EFL exposed for access by a beverage consumer for flavor enhancement of a beverage in the BC by the beverage consumer.
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the FEA comprises corn syrup and water.
An embodiment wherein the SEA comprises corn syrup and water.
An embodiment wherein the FEA and SEA comprise corn syrup and water.
An embodiment wherein the RML comprises paper.
An embodiment wherein the RML comprises plastic.
An embodiment wherein the RML comprises silicone parchment paper.
An embodiment wherein the EFL comprises salt.
An embodiment wherein the EFL comprises a food flavoring approved by the United States Food and Drug Administration (FDA).
An embodiment wherein the EFL comprises citrus flavoring.
An embodiment wherein the EFL comprises sugar.
An embodiment wherein the ESL comprises gelatin.
An embodiment wherein the ESL comprises gelatin, sugar, and water.
An embodiment wherein the RML comprises a removal tab.
An embodiment wherein the EFL is covered by a flavor protective layer (FPL).
An embodiment wherein the FEA penetrates the ESL to contact the RML.
An embodiment wherein the SEA is omitted and the FEA penetrates the ESL to contact the RML.
An embodiment wherein the FEA overlaps the ESL to contact the RML.
An embodiment wherein the SEA is omitted and the FEA overlaps the ESL to contact the RML.
An embodiment wherein the FEA penetrates and overlaps the ESL to contact the RML.
An embodiment wherein the SEA is omitted and the FEA penetrates and overlaps the ESL to contact the RML.
An embodiment wherein the BFS is formed as a cylindrical surface for attachment to a cylindrical beverage container.
An embodiment wherein the BFS is formed as a conical surface for attachment to the neck of a beverage container.
An embodiment wherein the EFL comprises an edible material selected from a group consisting of: salt; citrus flavoring; one or more spices; and one or more sugar flavors.
An embodiment wherein the EFL comprises a spice flavoring selected from a group consisting of: chili lime; pickle flavor; and hot lime flavor.
An embodiment wherein the EFL comprises a sugar flavoring selected from a group consisting of: cane sugar; peach; strawberry; and fruit.
An embodiment wherein the EFL comprises sugar.
An embodiment wherein the ESL comprises an ingredient selected from a group consisting of: gelatin; and glucose syrup.
An embodiment wherein the ESL comprises gelatin, sugar, and water.
An embodiment wherein the ESL comprises glucose syrup, sugar, and wheat flour.

One skilled in the art will recognize that other embodiments are possible based on combinations of elements taught within the above invention description.

### CONCLUSION

A beverage flavor strip (BFS) system/method allowing edible flavoring to be attached to the outside of a beverage container (BC) has been disclosed. The system/method integrates an edible strip layer (ESL), edible flavoring layer (EFL), first edible adhesive layer (FEA), second edible adhesive layer (SEA), and release material layer (RML) into a unified BFS that may be attached to the outside of a BC. The ESL is formed with a first outward face (FOF) and a second inward face (SIF). The FOF and SIF are coated with the FEA/SEA respectively to form a first adhesive side (FAS) and a second adhesive side (SAS). The FAS is coated with the EFL and the SAS is coated with the RML. The RML may be removed from the SAS to allow the SEA to be attached to the BC and expose the EFL for beverage flavor enhancement by the beverage consumer.

### CLAIMS INTERPRETATION

The following rules apply when interpreting the CLAIMS of the present invention:
The CLAIM PREAMBLE should be considered as limiting the scope of the claimed invention.
“WHEREIN” clauses should be considered as limiting the scope of the claimed invention.
“WHEREBY” clauses should be considered as limiting the scope of the claimed invention.
“ADAPTED TO” clauses should be considered as limiting the scope of the claimed invention.
“ADAPTED FOR” clauses should be considered as limiting the scope of the claimed invention.
The term “MEANS” specifically invokes the means-plus-function claims limitation recited in 35 U.S.C. § 112(f) and such claim shall be construed to cover the corresponding structure, material, or acts described in the specification and equivalents thereof.
The phrase “MEANS FOR” specifically invokes the means-plus-function claims limitation recited in 35 U.S.C. § 112(f) and such claim shall be construed to cover the corresponding structure, material, or acts described in the specification and equivalents thereof.
The phrase “STEP FOR” specifically invokes the step-plus-function claims limitation recited in 35 U.S.C. § 112(f) and such claim shall be construed to cover the corresponding structure, material, or acts described in the specification and equivalents thereof.
The step-plus-function claims limitation recited in 35 U.S.C. § 112(f) shall be construed to cover the corresponding structure, material, or acts described in the specification and equivalents thereof ONLY for such claims including the phrases “MEANS FOR”, “MEANS”, or “STEP FOR”.
The phrase “AND/OR” in the context of an expression “X and/or Y” should be interpreted to define the set of “(X and Y)” in union with the set “(X or Y)” as interpreted by Ex Parte Gross (USPTO Patent Trial and Appeal Board, Appeal 2011-004811, Ser. No. 11/565,411, (“‘and/or’ covers embodiments having element A alone, B alone, or elements A and B taken together”).
The claims presented herein are to be interpreted in light of the specification and drawings presented herein with sufficiently narrow scope such as to not preempt any abstract idea.
The claims presented herein are to be interpreted in light of the specification and drawings presented herein with sufficiently narrow scope such as to not preclude every application of any idea.
The claims presented herein are to be interpreted in light of the specification and drawings presented herein with sufficiently narrow scope such as to preclude any basic mental process that could be performed entirely in the human mind.
The claims presented herein are to be interpreted in light of the specification and drawings presented herein with sufficiently narrow scope such as to preclude any process that could be performed entirely by human manual effort.

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

What is claimed is:

1. A beverage flavor strip (BFS) system comprising:
(a) edible flavoring layer (EFL);
(b) first edible adhesive layer (FEA);
(c) edible strip layer (ESL);
(d) second edible adhesive layer (SEA); and
(e) release material layer (RML);
wherein:
said ESL comprises a first outward face (FOF) and a second inward face (SIF);
said FOF is coated with said FEA to form a first adhesive side (FAS);
said SIF is coated with an SEA that form a second adhesive side (SAS);
said FAS is coated with said EFL;
said SAS is coated with said RML; and
said RML is configured to be removed from said SEA to allow attachment of said SEA to a beverage container (BC) with said EFL exposed for access by a beverage consumer for flavor enhancement of a beverage in said BC by said beverage consumer.

2. The beverage flavor strip system of claim 1 wherein said FEA and said SEA comprise corn syrup and water.

3. The beverage flavor strip system of claim 1 wherein said EFL comprises an edible material selected from a group consisting of: salt; citrus flavoring; one or more spices; and one or more sugar flavors.

4. The beverage flavor strip system of claim 1 wherein said EFL comprises a spice flavoring selected from a group consisting of: chili lime; pickle flavor; and hot lime flavor.

5. The beverage flavor strip system of claim 1 wherein said EFL comprises a sugar flavoring selected from a group consisting of: cane sugar; peach; strawberry; and fruit.

6. The beverage flavor strip system of claim 1 wherein said ESL comprises an ingredient selected from a group consisting of: gelatin; and glucose syrup.

7. The beverage flavor strip system of claim 1 wherein said ESL comprises gelatin, sugar, and water.

8. The beverage flavor strip system of claim 1 wherein said ESL comprises glucose syrup, sugar, and wheat flour.

9. The beverage flavor strip system of claim 1 wherein said RML comprises a material selected from a group consisting of: paper; plastic; and silicone parchment paper.

10. A beverage flavor strip (BFS) method comprising:
(1) forming a beverage flavor strip (BFS) by sandwiching an edible flavoring layer (EFL), first edible adhesive layer (FEA), edible strip layer (ESL), second edible adhesive layer (SEA), and release material layer (RML) into a unified structure;
(2) removing said RML from said BFS; and
(3) attaching said SEA to a beverage container (BC);
wherein:
said ESL comprises a first outward face (FOF) and a second inward face (SIF);
said FOF is coated with said FEA to form a first adhesive side (FAS);
said SIF is coated with an SEA that form a second adhesive side (SAS);
said FAS is coated with said EFL;
said SAS is coated with said RML; and
said RML is configured to be removed from said SEA to allow attachment of said SEA to said beverage container (BC) with said EFL exposed for access by a beverage consumer for flavor enhancement of a beverage in said BC by said beverage consumer.

11. The beverage flavor strip method of claim 10 wherein said FEA and said SEA comprise corn syrup and water.

12. The beverage flavor strip method of claim 10 wherein said EFL comprises an edible material selected from a group consisting of: salt; citrus flavoring; one or more spices; and one or more sugar flavors.

13. The beverage flavor strip method of claim 10 wherein said EFL comprises a spice flavoring selected from a group consisting of: chili lime; pickle flavor; and hot lime flavor.

14. The beverage flavor strip method of claim 10 wherein said EFL comprises a sugar flavoring selected from a group consisting of: cane sugar; peach; strawberry; and fruit.

15. The beverage flavor strip method of claim 10 wherein said ESL comprises an ingredient selected from a group consisting of: gelatin; and glucose syrup.

16. The beverage flavor strip method of claim 10 wherein said ESL comprises gelatin, sugar, and water.

17. The beverage flavor strip method of claim 10 wherein said ESL comprises glucose syrup, sugar, and wheat flour.

18. The beverage flavor strip method of claim 10 wherein said RML comprises a material selected from a group consisting of: paper; plastic; and silicone parchment paper.

19. A beverage flavor strip (BFS) system comprising:
(a) edible flavoring layer (EFL);
(b) first edible adhesive layer (FEA);
(c) edible strip layer (ESL); and
(d) protective packaging envelope (PPE);
wherein:
said ESL comprises a first outward face (FOF) and a second inward face (SIF);
said FOF is coated with said FEA to form a first adhesive side (FAS);
said FAS is coated with said EFL;
said ESL, said FEA, and said EFL are configured to form a layered flavor strip (LFS);
said PPE forms a hermetically sealed envelope having an internal retention cavity (IRC) of sufficient volume to contain said LFS; and
said LFS is contained within said IRC.

20. The beverage flavor strip system of claim 19 wherein said FEA comprises corn syrup and water.

21. The beverage flavor strip system of claim 19 wherein said EFL comprises an edible material selected from a group consisting of: salt; citrus flavoring; one or more spices; and one or more sugar flavors.

22. The beverage flavor strip system of claim 19 wherein said EFL comprises a spice flavoring selected from a group consisting of: chili lime; pickle flavor; and hot lime flavor.

23. The beverage flavor strip system of claim 19 wherein said EFL comprises a sugar flavoring selected from a group consisting of: cane sugar; peach; strawberry; and fruit.

24. The beverage flavor strip system of claim 19 wherein said ESL comprises an ingredient selected from a group consisting of: gelatin; and glucose syrup.

25. The beverage flavor strip system of claim 19 wherein said ESL comprises gelatin, sugar, and water.

26. The beverage flavor strip system of claim 19 wherein said ESL comprises glucose syrup, sugar, and wheat flour.

27. A beverage flavor strip (BFS) system comprising:
(a) edible flavoring layer (EFL);
(b) edible strip layer (ESL); and
(c) protective packaging envelope (PPE);
wherein:
said ESL comprises a first outward face (FOF) and a second inward face (SIF);
said FOF is coated with said EFL;
said ESL and said EFL are configured to form a layered flavor strip (LFS);
said PPE forms a hermetically sealed envelope having an internal retention cavity (IRC) of sufficient volume to contain said LFS; and
said LFS is contained within said IRC.

28. The beverage flavor strip system of claim 27 wherein said EFL comprises an edible material selected from a group consisting of: salt; citrus flavoring; one or more spices; and one or more sugar flavors.

29. The beverage flavor strip system of claim 27 wherein said EFL comprises a spice flavoring selected from a group consisting of: chili lime; pickle flavor; and hot lime flavor.

30. The beverage flavor strip system of claim 27 wherein said EFL comprises a sugar flavoring selected from a group consisting of: cane sugar; peach; strawberry; and fruit.

31. The beverage flavor strip system of claim 27 wherein said ESL comprises an ingredient selected from a group consisting of: gelatin; and glucose syrup.

32. The beverage flavor strip system of claim 27 wherein said ESL comprises gelatin, sugar, and water.

33. The beverage flavor strip system of claim 27 wherein said ESL comprises glucose syrup, sugar, and wheat flour.
